(19) United States
(12) Patent Application Publication
(10) Pub. No.: US 2006/0290086 A1
(43) Pub. Date: Dec. 28, 2006

(54) Mobile closet with wheels

(76) Inventor: Justin Holder, Rosedale, NY (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/475,364

(22) Filed: Jun. 27, 2006

Related U.S. Application Data
(60) Provisional application No. 60/694,428, filed on Jun. 27, 2005.

(51) Int. Cl. B62B 1/00

(52) U.S. Cl. 280/79.3

(57) ABSTRACT

A holder comprising of a plurality of sheet walls constructed from plywood; a plurality of notches located at the bottom of the sheet walls for permitting the holder to be lifted by a forklift, said walls being configured to be vertically stacked and docked; and a plurality of wheels or casters.

### CLAIM OF PRIORITY

This application claims benefit to provisional application 60/694,428, filed on Jun. 27, 2005, entitled “Mobile Closet with Wheels”, which is incorporated herein in its entirety.

### FIELD OF THE INVENTION

The present invention is directed to the field of mobile closets. In particular, the present invention is directed to a mobile closet with wheels.

### BACKGROUND OF THE INVENTION

This particular invention is a mobile storage and moving unit which results in a unique device for the purpose of moving and storage. The device makes it possible to utilize the most efficient means of moving and storage, provided that the building is equipped with certain features.

There have been a number of patents directed toward the field of portable closet containers. U.S. Pat. No. 4,421,260 is directed to a portable clothes closet to be attached to a vehicle. The clothes closet has an attachment means to be secured to the frame of a vehicle. A base means is provided which can be releasably attached to the attachment means on the vehicle and provides a surface to support the storage device. A frame with a cross bar is provided from which to hang clothes and the frame is releasably attached to the base means. An enclosure is provided for the frame and is releasably attached to the base means to provide a protective sheath for the mobile clothes closet.

U.S. Pat. No. 5,379,466 is directed to a portable privacy closet which may be selectively moved from a raised to a lowered position such that when the closet is in the raised position it provides a private area for use as a changing room or for housing a toilet facility, and when in the lowered position, the closet provides a weather tight storage area. The portable privacy closet includes a base having a pair of parallel spaced apart sidewalls, a rear wall, a bottom wall and a front wall which includes a door which seals to the front wall when in the closed position. A top portion telescopically engages the base and includes a pair of parallel spaced apart sidewalls, a rear wall and a front wall formed with an access opening, selectively closed by either a curtain or a door. The top portion is selectively moved into and out of telescopic engagement with the base via a plurality of cables attached at a first end to a spool supported by the base, and attached at a second end to the top portion such that rotation of the spool causes the top portion to raise out of telescopic engagement with the base.

U.S. Pat. No. 4,912,887 discloses a portable stage apparatus which utilizes a plurality of open frame assemblies, each of which is constructed of a plurality of pivotally interconnected side panels. Each open frame assembly is mounted on wheels to facilitate movement from a collapsed position to an extended position. When in the extended position, a plurality of floor panels are to be mounted on the open frame assemblies with the floor panels being contiguous and the upper surface of the floor panels being in alignment. Adjoining floor panels are interlocked together with these floor panels also being locked to the open frame assemblies. For purposes of stowage and transportability, the open frame assemblies are connectable together in the collapsed position and readily movable onto a transporting vehicle. Also, a group of the floor panels are capable of being stowed together into a small space and mounted onto a storage dolly which is readily movable onto and off of a transporting vehicle.

U.S. Pat. No. 5,718,350 discloses a container including a base portion having a bottom surface, front and rear walls extending upwardly from the bottom surface, and opposed side walls extending upwardly from the bottom surface and, together with the front and rear walls, defining an open top. A cover is provided to close the open top and may be selectively attached to the rear wall by hinge assemblies and to the front wall by a latch mechanism. A side handle is positioned in a recess formed in each side wall and may be pivoted from a position in the recesses to the carrying position outside the recesses. A track on the upper surface of the cover may be received within a platform on the lower surface of the cover of a like container to stack the same. Similarly, a chamber is formed near the periphery of the bottom surface of base portion and can be received within the track of the cover of a like container to stack the same.

U.S. Patent Publication No. 2004/0118742 discloses a portable clothes closet to be attached to a vehicle. The clothes closet has an attachment means to be secured to the frame of a vehicle. A base means is provided which can be releasably attached to the attachment means on the vehicle and provides a surface to support the storage device. A frame with a cross bar is provided from which to hang clothes and the frame is releasably attached to the base means. An enclosure is provided for the frame and is releasably attached to the base means to provide a protective sheath for the mobile clothes closet.

Great Britain Patent No. 2,280,360 discloses a container which may be used as a transportation trunk and as a piece of furniture. This enables a single container to be used for both transportation of goods and their storage. The container has wheels and a door and may be provided internally with shelves or a wardrobe hanging rail. It may be made of multi-laminated plywood.

It is an object of the present invention to provide a stackable holder which can be loaded in a vertical position.

It is a further object of the invention to provide a system in which the stackable holder includes notches for a fork lift.

It is yet another object of the present invention to provide a multi-drawer holding cabinet which can be stacked.

### SUMMARY OF THE INVENTION

The mobile storage unit is a large box constructed from three sheets of standard plywood (eight feet by four feet). It has a docking capability, allowing the unit to dock securely with a removable bottom portion for transport. The dock is easily removed when the holder is not being transported. The holder has specially measured notches that allow the holder to be picked up by a forklift. The notches allow the holders to be stacked on top of each other and securely fit together. As a result of the design, the holders stack on top of one another and dock securely in a vertical position.

The size, scale and construction of the holder creates a mobile storage and moving unit that can fit inside of most elevators. This makes moving and storage activities in elevator equipped buildings extremely easy.

Due to the specially engineered pivot point, the design of the holder enables the “mover” to lift heavy loads. This pivot point is designed to facilitate the docking of the holder. The docking allows the holder to be easily rolled away. The pivot point also fits within the unique size and construction requirements to make it unique. The dock of the holder is a small rolling “seat” that the holder, by its pivot action, is able to rest on and securely fit in to. The design enables this because it consists of notches and unique resting surfaces.

In a preferred embodiment, the invention is a holder comprising of a plurality of sheet walls constructed from plywood and a plurality of notches located at the bottom of the sheet walls, permitting the holder to be lifted by a forklift.

In a further embodiment, the invention is a holder comprising of a plurality of sheet walls constructed from plywood; a plurality of notches located at the bottom of the sheet walls for permitting the holder to be lifted by a forklift, said walls being configured to be vertically stacked and docked; and a plurality of wheels or casters.

### BRIEF DESCRIPTION OF THE DRAWINGS

FIG. 1 is an overhead view of the present invention.

FIG. 2 is a side perspective view of the present invention.

FIGS. 3 and 4 are perspective views of the present invention.

FIGS. 5 and 6 are side by side cabinets in accordance with the present invention.

FIGS. 7 to 9 are alternative perspective views of the present

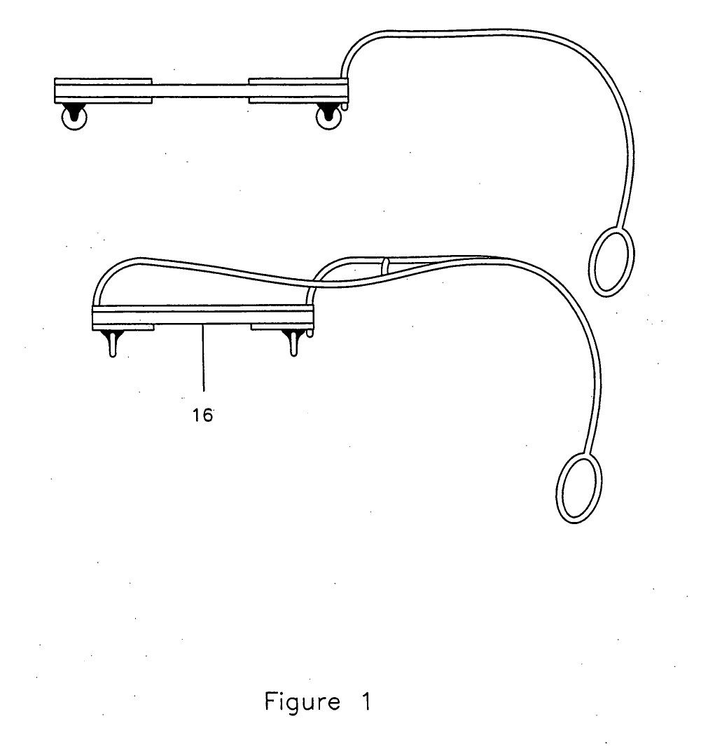

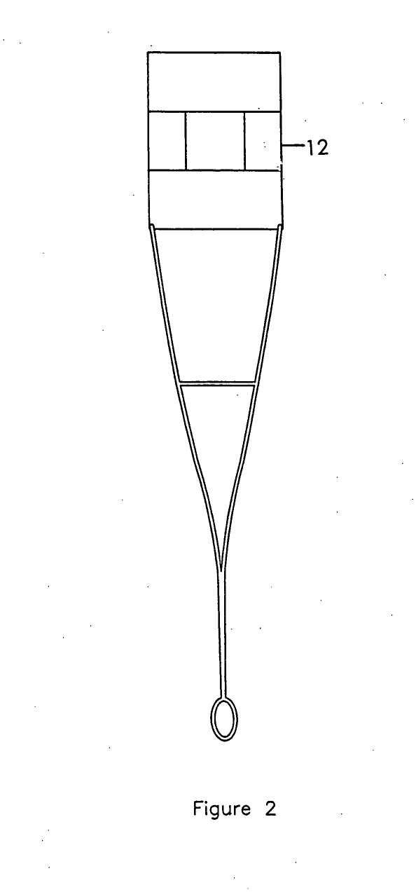

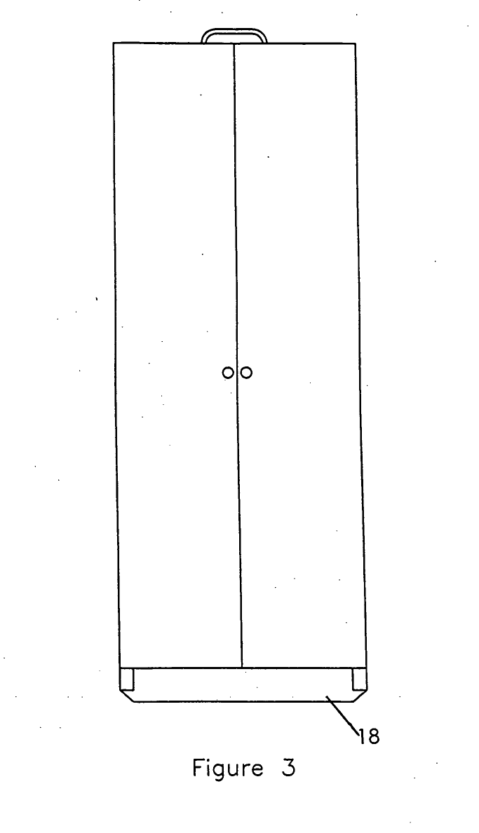

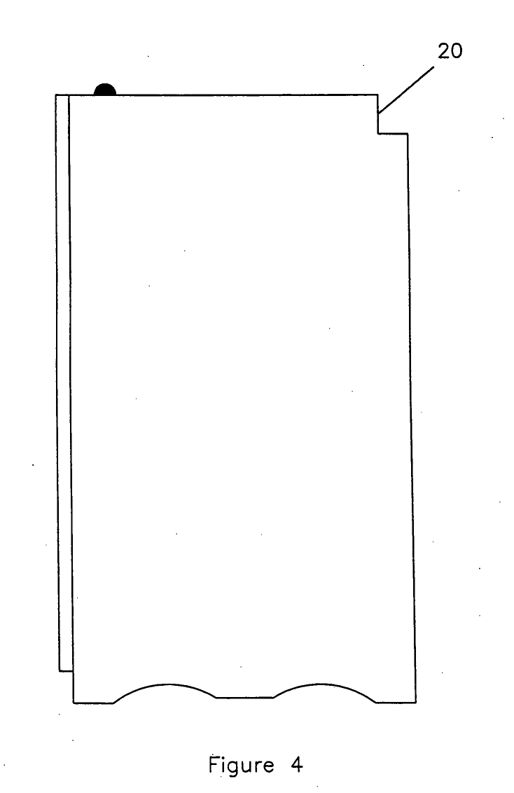

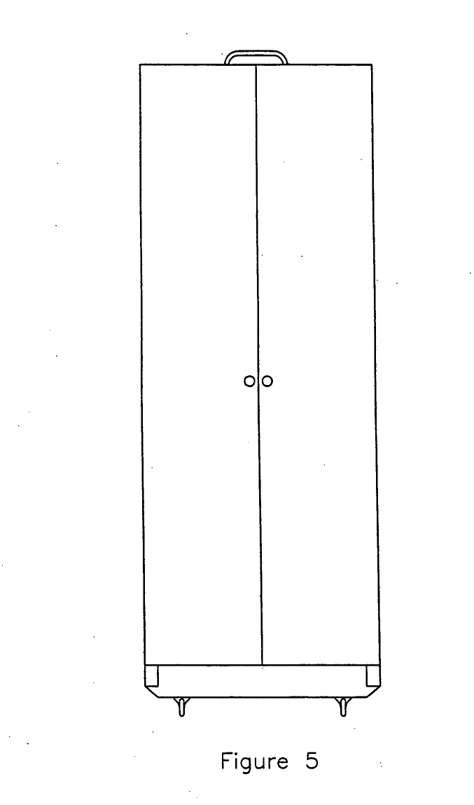

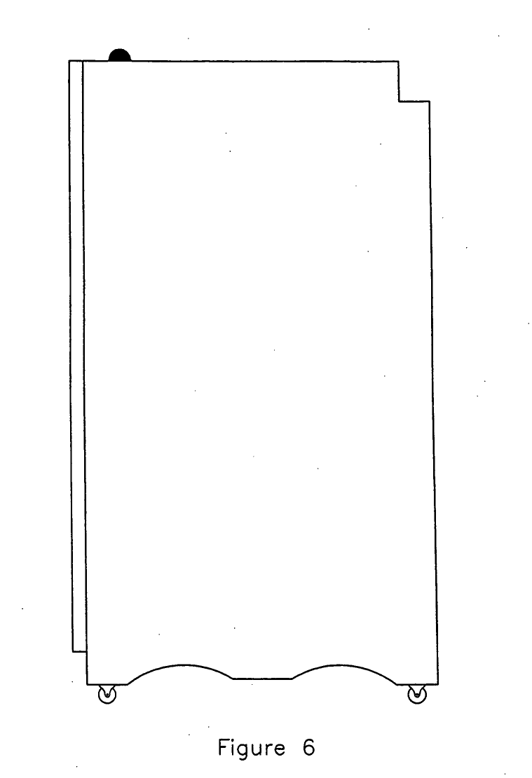

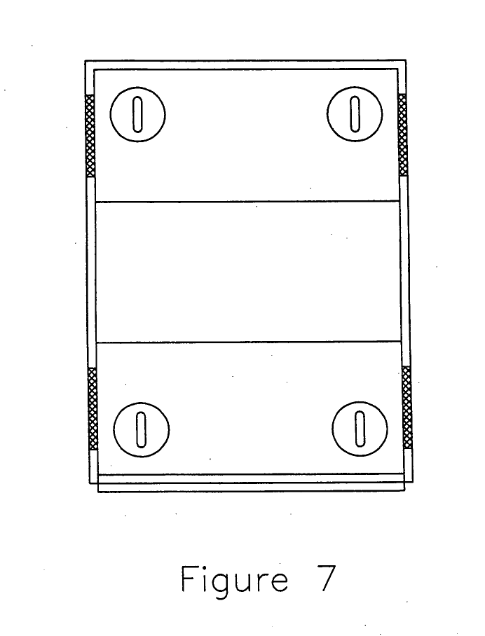

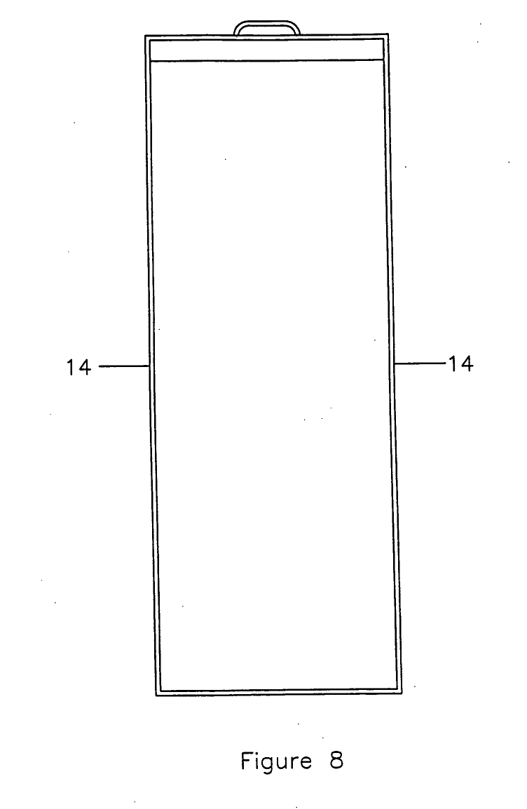

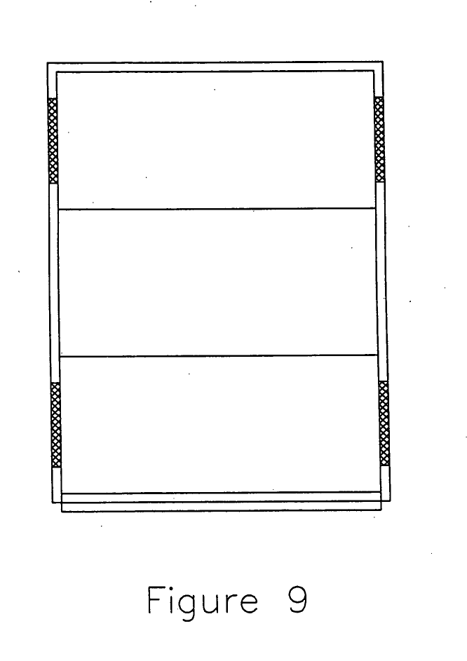

### DESCRIPTION OF THE PREFERRED EMBODIMENT

The present invention is described with reference to the enclosed Figures wherein the same numbers are utilized where applicable. The present invention is a mobile storage unit 10. In a most preferred embodiment, the invention is a large box 12 constructed from three sheets of standard plywood 14 (eight feet by four feet) or other rigid material such as steel or aluminum.

The holder of the invention provides a docking capability 16, in that it docks securely with a removable bottom portion 16 for transport. The dock 16 is easily removed from the holder when the holder is not being transported. The holder has specially measured notches 18, which allow the holder to be picked up by a forklift. These notches allow the holders to be stacked on top of one another and securely fit together. The holders 10, because of their design, stack on top of each other and dock securely in a vertical position.

The size, scale and construction of the holder results in a mobile storage and moving unit that can fit inside most elevators. This makes moving and storage activities in elevator equipped buildings extremely easy.

Due to its specially engineering pivot point 20, the design of the holder enables the “mover” to lift heavy loads. This pivot point 20 is designed to facilitate the docking of the holder. The docking allows the holder to be easily rolled away. The pivot point also fits within the unique size and construction requirements to make it unique.

The dock of the holder is a small rolling “seat” that the holder, by its pivot action, is able to rest on and securely fit in to. The design enables this because it consists of notches and unique resting surfaces.

The present invention has been described with reference to the above discussed preferred embodiment. The true nature and scope of the invention is to be determined with reference to the claims appended hereto.

1. A holder comprising:
a plurality of sheet walls constructed from plywood; and
a plurality of notches located at the bottom of the sheet walls for permitting the holder to be lifted by a forklift.

2. The holder of claim 1, wherein the walls are configured to be vertically stacked and docked.

3. The holder of claim 1, further comprising a plurality of wheels or casters.

4. A holder comprising:
a plurality of sheet walls constructed from plywood;
a plurality of notches located at the bottom of the sheet walls for permitting the holder to be lifted by a forklift, said walls being configured to be vertically stacked and docked; and
a plurality of wheels or casters; said holder having a pivot point.
